(19) United States
(12) Patent Application Publication
(10) Pub. No.: US 2009/0305657 A1
(43) Pub. Date: Dec. 10, 2009

(54) ANTENNA DEVICE AND RADIO WAVE-USING APPARATUS

(75) Inventor: Kaoru SOMEYA, Kiyose-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/478,035

(22) Filed: Jun. 4, 2009

(30) Foreign Application Priority Data
Jun. 5, 2008 (JP) 2008-147744

(51) Int. Cl. H04B 1/06; H01Q 7/08

(52) U.S. Cl. 455/269; 343/788

(57) ABSTRACT

An antenna device receives radio waves, excites received signals corresponding to the received radio waves, and transmits the received signals to a radio wave-using operation module block including received signal using elements. The radio wave-using operation module block includes a pair of flat surfaces facing in opposite directions and an outer circumferential surface connecting the peripheral edges of the flat surfaces to each other. The antenna device includes an elongate antenna core member which extends along the outer circumferential surface of the radio wave-using operation module block, and an antenna coil which is wound around at lease a part of the antenna core member in the longitudinal direction thereof and which is connected to the received signal using elements of the radio wave-using operation module block.

### CROSS-REFERENCE TO RELATED APPLICATIONS

This application is based upon and claims the benefit of priority from prior: Japanese Patent Application No. 2008-147744, filed Jun. 5, 2008, the entire contents of which are incorporated herein by reference.

### BACKGROUND OF THE INVENTION

1. Field of the Invention

The present invention relates to an antenna device and a radio wave-using apparatus.

2. Description of the Related Art

As a radio wave-using apparatus, a radio wave controlled time piece, a radio, a cellular-phone, and the like are known.

A radio wave-using apparatus comprises an antenna device which receives radio waves and excites received signals corresponding to the received radio waves, a radio wave-using operation module block which includes received signal using elements using the received signals excited by the antenna device, and a case which has a housing space housing the antenna device and the radio wave-using operation module block.

When the case is made of a conductive material such as metal, external radio waves are interrupted by the conductive housing, and a receiving sensitivity of the antenna device housed in the housing space of the case is decreased.

In the case that the radio wave-using apparatus is a wristwatch type radio wave controlled time piece, a watch case as a case is small so that the size of an antenna device housed in a housing space of the watch case must be reduced and so that the receiving sensitivity of the antenna device is necessarily lowered.

In the technical field of the wrist watch type radio wave controlled time piece, it has been required to decrease the outer dimensions of the watch case while increasing the receiving sensitivity of the antenna device.

U.S. Pat. No. 6,927,739 B2 discloses a configuration to increase the receiving sensitivity of the antenna device in the wristwatch type radio wave controlled time piece.

This conventional antenna device comprises a straight line shaped antenna core member on which a coil is wound and an elongate magnetic radio wave catching part attached to each of the both ends of the antenna core member and extending in a direction crossing the longitudinal direction of the antenna core member. Each of the radio wave-catching parts has a straight line shape or a circular arc shape. The combination of the antenna core member and the radio wave-catching parts provides a substantially H-shape as a whole.

This conventional antenna device is housed in the housing space of the watch case of the wrist watch type radio wave controlled time piece so that the straight line shaped antenna core member is laid along the bottom surface of the housing space and the radio wave-catching parts at the both ends of the antenna core member are extended along the inner circumferential surface of the housing space.

The housing space, of the watchcase must house a watch module and a primary battery or a secondary battery with a solar battery, in addition to the antenna device. This increases the depth and/or diameter of the housing space and finally increases the outside dimensions of the watchcase.

The present invention is derived from the above described circumstances, and an object of the present invention is to provide an antenna device, which is decreased in the size and increased in the radio wave-receiving sensitivity and which can decrease the outside dimensions of a case of a radio wave-using apparatus, and a radio wave-using apparatus using the antenna device.

### BRIEF SUMMARY OF THE INVENTION

According to an aspect of the present invention, an antenna device, which receives radio waves, which excites received signals corresponding to the received radio waves, and which transmits the received signals to a radio wave-using operation module block including received signal using elements, the radio wave-using operation module block including a pair of flat surfaces facing in opposite directions and an outer circumferential surface connecting the peripheral edges of the flat surfaces to each other, comprises: an elongate antenna core member which extends along the outer circumferential surface of the radio wave-using operation module block; and an antenna coil which is wound around at least a part of the antenna core member located in the longitudinal direction thereof and which is connected to the received signal, using elements of the radio wave-using operation module block.

According to an aspect of the present invention, a radio wave-using apparatus comprises an antenna device which receives radio waves and which excites received signals corresponding to the received signals; a radio wave-using operation module block including received signal using elements which uses the received signals excited by the antenna device; and a case which has a housing space housing the antenna device and the radio wave-using operation module block. And, the radio wave-using operation module block includes a pair of flat surfaces facing in opposite directions and an outer circumferential surface connecting the peripheral edges of the flat surfaces to each other. The antenna device includes an elongate antenna core member which extends along the outer circumferential surface of the radio wave-using operation module block, and an antenna coil which is wound around at least a part of the antenna core member located in the longitudinal direction thereof and which is connected to the received signal using elements of the radio wave-using operation module block.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic plan view of a main part of a wrist, watch type radio wave controlled time piece according to an embodiment of a radio wave-using apparatus of the present invention;

FIG. 2 is a schematic exploded perspective view of the main part of the wrist watch type radio wave controlled time piece of FIG. 1;

FIG. 3A is a schematic perspective view of a combination of an antenna device and a watch module as a radio wave-using operation, module block, both of which are housed in a housing space of a watch case of the wrist watch type radio wave controlled time piece of FIG. 1;

FIG. 3B is a schematic sectional view along a section line IIIB-IIIB in FIG. 3A;

FIG. 4 is a schematic plan view of a first modification of the antenna device combined with the watch module of FIG. 3A;

FIG. 5 is a schematic plan view of a second modification of the antenna device combined with the watch module of FIG. 3A;

FIG. 6 is a schematic plan view of a third modification of the antenna device combined with the watch module of FIG. 3A;

FIG. 7A is a schematic perspective view of a fourth modification of the antenna device combined with the watch module of FIG. 3A;

FIG. 7B is a schematic plan view of a fourth modification of the antenna device of FIG. 7A combined with the watch module of FIG. 3A;

FIG. 8A is a schematic front view of a fifth modification of the antenna device before it is combined with the watch module of FIG. 3A;

FIG. 8B is a schematic perspective view of the antenna device of FIG. 8 after it is combined with the watch module of FIG. 3A;

FIG. 8C is a schematic sectional view along a line VIIIC-VIIIC in FIG. 8B;

FIG. 9A is a schematic plan view of a first modification of the watch module of FIG. 3A and sixth modification of the antenna device combined with the watch module of the first modification;

FIG. 9B is a schematic plan view of a second modification of the watch module of FIG. 3A and seventh modification of the antenna device combined with the watch module of the second modification;

FIGS. 10A, 10B and 10C are plan views, each schematically showing the flow of magnetic lines of force around each of antenna core members, when the antenna core member of the antenna device according to the invention is shaped as semicircular, C-shaped with a gap between both extending ends thereof, and circular, respectively; and

FIGS. 11A, 11B and 11C are schematic side views showing three manufacturing methods for shaping the antenna core member of the antenna device according to the invention as circular.

### DETAILED DESCRIPTION OF THE INVENTION

In the followings, a wrist watch type radio wave controlled time piece which is according to an embodiment of a radio wave-using apparatus of the present invention, and various examples of a combination of a watch module as a radio wave-using operation module block and an antenna device both of which housed in a watch case of the wrist watch type radio wave controlled time piece, will be described with reference to attached drawings.

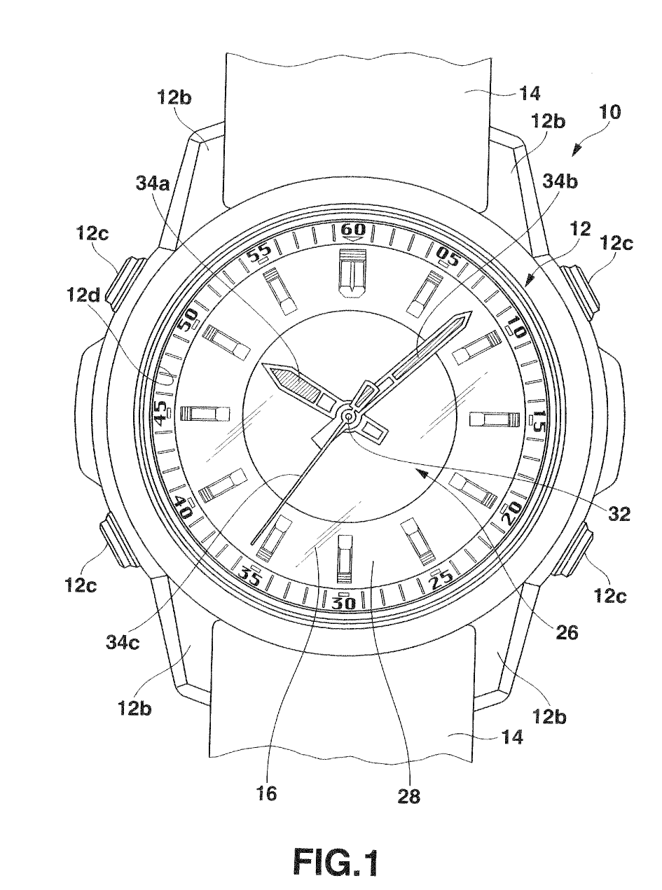

At first, with reference to FIG. 1 to FIG. 3B, a wrist watch type radio wave controlled time piece which is according to an embodiment of a radio wave-using apparatus of the present invention, and a combination of a watch module as a radio wave-using operation module block and an antenna device both of which housed in a watch case of the wrist watch type radio wave controlled time piece, will be described.

The wrist watch type radio wave controlled time piece 10 comprises a cylindrical watch case body 12 having a housing space 12a. The watch case body 12 is formed of a material having an electrical conductivity such as metal for example stainless, brass, titanium, etc. The housing space 12a opens in one and the other end flat surfaces of the watch case body 12, and communicates with the outer space through these openings.

A pair of band attaching portions 12b to which a base end part of each of a pair of watchbands is detachably attached, is formed at each of opposing parts on the outer circumferential surface of the watch case body 12. A plurality of operation buttons 12c is further provided on the outer circumferential surface of the watch case body 12.

The one opening 12d of the housing space 12a of the watch case body 12 is covered with a watch glass 16 which is a light transmittable member. The other opening 12e of the housing space 12a of the watch case body 12 is covered with a back cover 18. The back cover 18 is formed of a material having an electrical conductivity such metal, like the watch case body 12. The back cover 18 is detachably fixed to the other end flat surface of the watch case body 12 so that the back cover 18 together with the watch case body 12 provides a case for the wrist watch type radio wave controlled time piece 10.

An antenna device 20 and a watch module 24 as a radio wave-using operation module block are housed between the watch glass 16 and the back cover 18 in the housing space 12a of the watch case body 12. The antenna device 20 receives radio waves and excites received signals corresponding to the received radio waves. The watch module 24 includes various received signal-using elements 22 which use the received signals excited by the antenna device 20. These various received signal-using elements 22 configure electric or electronic circuits which perform various known functions and which include a well known time piece circuit for counting time.

These electric or electronic circuits of the watch module 24 are configured to be controlled their actions by the plurality of operation buttons 12c on the cuter circumferential surface of the watch case body 12.

In this embodiment, the watch module 24 includes a time display unit 26 which is visible from the outside space through the watch glass 16 covering the one opening 12d of the housing space 12a of the watch case body 12. The time display unit 26 is configured to display the time counted by the above described well known time piece circuit.

In this embodiment, the time display unit 26 Includes a dial plate 28 which is located in the inside of the watch glass 16 in the housing space 12a of the watch case body 12 to face the watch glass 16. The time display unit 26 further includes a stepping motor 30 which is located in the inside of the dial plate 28. An output shaft of the stepping motor 30 which is not shown is connected to a hand shaft unit driving mechanism including a well known hand shaft unit 32 which projects from the stepping motor 30 into the outer surface of the dial plate 28 through a center through hole of the dial plate 28.

The projecting end of the hand shaft unit 32 is located between the watch glass 16 and the dial plate 28 in the housing space 12a of the watch case body 12, and a base end part of at least one well known hand, in this embodiment base parts of hour hand 34a, minute hand 34b and second hand 34c, is connected to the projecting end of the hand shaft unit 32.

In this embodiment, the watch module 24 further includes a battery 36 which supplies an electric power for driving the various received signal using elements 22 and the time display unit 26.

The battery 36 may be a primary battery or a secondary battery which is used in combination with a solar battery. In the case that the battery 36 is the secondary battery, the dial plate 28 is formed by a light transmissible material and the solar battery is arranged in the inner side of the dial plate 28.

The well known time piece circuit which includes various received signal using elements 22 being supplied with the electric power from the battery 36, counts the present time and transmits the time signal corresponding to the counted present time to the stepping motor 30. The stepping motor 30 being supplied with the electric power from the battery 36, rotates the not shown output shaft on the basis of the time signal, and then moves the hour hand 34a, minute hand 34b and second hand 34c on the outer surface of the dial plate 28 through the hand shaft unit 32 to display the present time. That is, in this embodiment, the combination of the stepping motor 30, the above described well known hand shaft unit driving mechanism including the hand shaft unit 32, the hour hand 34a, the minute hand 34b, the second hand 34c, and the dial plate 28 provides the time display unit 26.

As the time display unit 26, in place of the above described combination, a well known time image display unit which displays a time by an image as for example a liquid display unit, may be used or the time image display unit may be used in addition to the above described combination. In addition to the time, results of various actions set in the above described electric or electronic circuits of the watch module 24 by the plurality of operation buttons 12c on the outer circumferential surface of the watch case body 12, can be displayed on the time image display unit.

In this embodiment, the radio waves received by the antenna device 20 contain standard time information. In this embodiment, the above described well known time piece circuit which is configured by the various received signal using elements 22 of the watch module 24, renews the present time counted by the above described time piece circuit on the basis of the standard time information contained in the radio waves received by the antenna device 20.

In this embodiment, the various received signal using elements 22 of the watch module 24, together with the stepping motor 30 and the above described hand shaft unit driving mechanism including the well known hand shaft unit 32, configures a substantially circular disc shape the outer surface region of which has a pair of flat surfaces facing in opposite directions and an outer circumferential surface connecting the peripheral edges of the flat surfaces to each other. A battery holding concavity 36a which detachably holds the battery 36 is formed in the outer surface region of this substantially circular disc shaped watch module 24. And, in this embodiment, the outer surface region of the watch module 24 is covered with electrically nonconductive material such as plastic.

In this embodiment, the antenna device 20 comprises an elongated antenna core member 20a which extends along the outer circumferential surface of the watch module 24, and an antenna coil 20b which is wound around at least a part of the antenna core member 20a in the longitudinal direction thereof.

The antenna coil 20b is connected to the above described time piece module configured by the various received signal using elements 22 in the watch module 24.

In this embodiment, it is preferable that the antenna core member 20a includes a plurality of laminated elongate sheet-like magnetic materials and extends circularly along the whole outer circumferential surface of the watch module 24. Further, the whole antenna core member 20a has the same width and the same thickness at all positions in the longitudinal direction thereof. That is, the cross sectional area of the whole antenna core member 20a is constant in its longitudinal direction.

The magnetic material is a band shaped foil which has a thickness less than 20 μm and which has a high relative permeability and a high electrical conductivity such as for example amorphous alloy, Fe—Cu—Nb—Si—B based nano-crystal magnetic alloy and the like, and Fe—Si based magnetic material and the like.

According to an aspect of the present invention, the antenna core member 20a can be made integrally with magnetic material such as ferrite, permalloy, and the like.

In this embodiment, the watch module 24 which is so combined with the antenna device 20 as described above, is housed between the dial plate 28 and the back cover 18 in the housing space 12a of the watch case body 12 while it is covered with a protection frame 38 formed in a cup shape by electrically non-conductive material such as plastic, excepting the dial plate 28 in the one flat surface side thereof.

That is, the inner circumferential surface of the housing space 12a of the watch case body 12 adjoins and opposes the antenna core member 29a of the antenna device 20 on the outer circumferential surface of the watch module 24 housed in housing space 12 as described above.

In the wrist watch type radio wave controlled time piece 10 according to this embodiment, the antenna device 20 which receives radio waves, which excites received signals corresponding to the received radio waves, and which transmits the received signals to the watch module 24 including the received signal using elements 22, is arranged along the outer circumferential surface of the watch module 24. Therefore, the dimensions of the housing space 12a of the watch case body 12 of the wrist watch type radio wave controlled time piece 10 for housing the watch module 24 with the antenna device 12 can be reduced, and thus the outer dimensions of the watch case body 12 can be reduced.

Moreover, the elongate antenna core member 20a of the antenna device 20 extends along the outer circumferential surface of the watch module 24 as the radio wave-using operation module block, and the antenna coil 20b is wound around only the part of the antenna core member 20a in the longitudinal direction thereof. Therefore, the large part of the antenna core member 20a around which the antenna coil 20b is not wound can be used as a radio wave catching part so that the radio wave receiving sensitivity of the antenna device 20 can be improved in comparison with the conventional one. Further, the antenna core member 20a which extends along the outer circumferential surface of the watch module 24 as the radio wave-using operation module block is placed at a position adjoining the one opening 12d covered with the watch glass 16 of the light transmittable member in the housing space 12a of the watch case body 12 of the electrically conductive material, and the radio waves are entered from the outer space into the housing space 12a through the one opening 12d. This improves the radio wave receiving sensitivity of the antenna device 20 in the housing space 12a.

[First Modification of the Antenna Device 20]

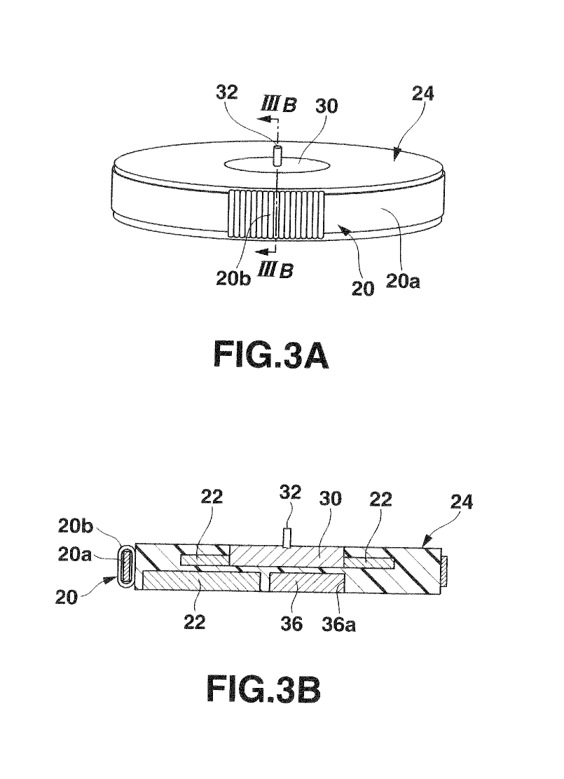

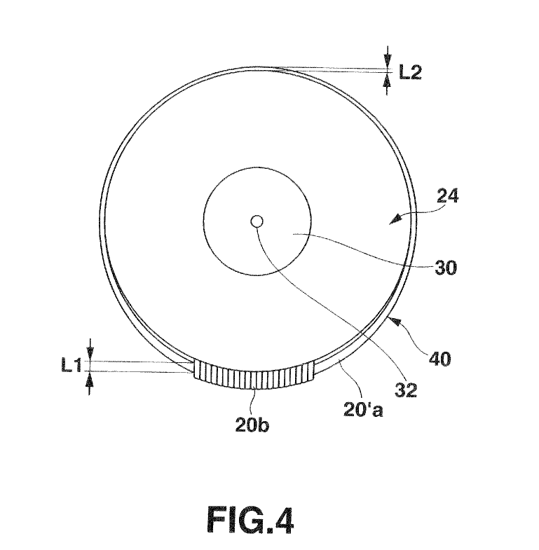

Next, a first modification of the antenna device 20 which is combined with the watch module 24 as the radio wave-using operation module block of FIG. 3A, will be described with reference to FIG. 4.

An antenna device 40 of the first modification is different from the antenna device 20 of the embodiment described above with reference to FIGS. 1 to 3B in that the sectional area of the antenna core member 20′a changes in the longitudinal direction thereof.

In the antenna core member 20′a of the antenna device 40 of the first modification shown in FIG. 4, the sectional area of the part around which the antenna coil 20b is wound is lager than that of the part which is located to oppose to the above described antenna coil wound part. Specifically, the sectional area of the antenna core member 20′a is gradually reduced in a direction being away from the antenna coil wound part along the outer circumferential surface thereof. In this modification, the thickness of the antenna core member 20′a is gradually reduced from the thickness L1 at the part around winch the antenna coil 20b is wound to the thickness L2 at the part which is located to oppose to the above described antenna coil wound part.

Increasing in the sectional area of the antenna core member 20′a means lowering in the magnetic resistance thereof. Therefore, the magnetic lines of the radio waves received by the antenna core member 20′a of the antenna device 40 of the first modification are easily collected to the part around which the antenna coil 10 is wound, so that the radio wave receiving sensitivity of the antenna device 40 of the first modification is improved.

In the combination of the antenna device 40 of the first modification and the watch module 24, the outer circumferential surface of the watch module 24 is so preferably shaped that the outer circumferential surface of the antenna core member 20′a of the antenna. device 40 of the first modification is a circle the center of which coincides with the center of the combination. Further, an indent which receives the antenna coil 20b wound around the part of the antenna core member 20′a is preferably formed in the outer circumferential surface of the watch module 24.

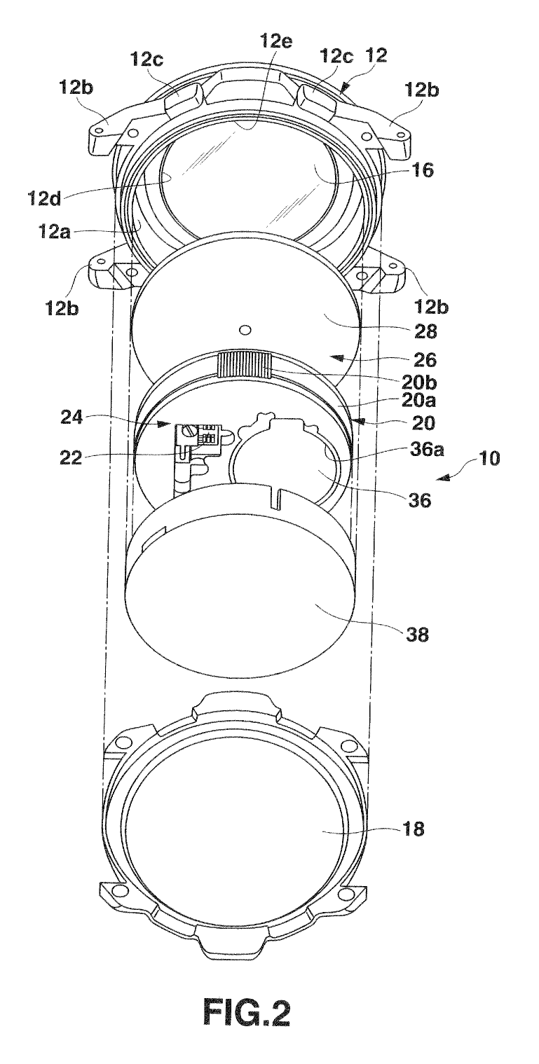

With this configuration, a substantially crescent moon shaped gap corresponding to the change in the thickness of the antenna core member 20′a in the longitudinal direction thereof and a gap corresponding to the thickness of the antenna coil 20b will not be produced between the inner circumferential surface of the housing space 12a of the watch case body 12 (see FIG. 2) and the outer circumferential surface of the protection frame 38 or between the inner circumferential surface of the protection frame 38 and the outer circumferential surface of the antenna device 40 combined with the watch module 24. This means that the inner diameter needed for housing the above described combination in the housing space 12a of the watch case body 12 (see FIG. 2) can be reduced, and thus the outer diameter of the watch case body 12 can be reduced.

Further, the antenna coil receiving indent provided in the outer circumferential makes the positioning of the antenna device 40 on the outer circumferential surface of the watch module 24 ease when the antenna device 40 is combined with the outer circumferential surface of the watch module 24.

In this modification, the thickness of the antenna core member 20′a is changed at the position in the longitudinal direction of the antenna core member 20′a to change the cross sectional area of the antenna core member 20′a of the antenna device 40 of the modification. However, the width of the antenna core member 20′a can be changed at the position in the longitudinal direction of the antenna core member 20′a, and both the width and the thickness of the antenna core member 20′a can be changed at the position in the longitudinal direction of the antenna core member 20′a.

[Second Modification of the Antenna Device 20]

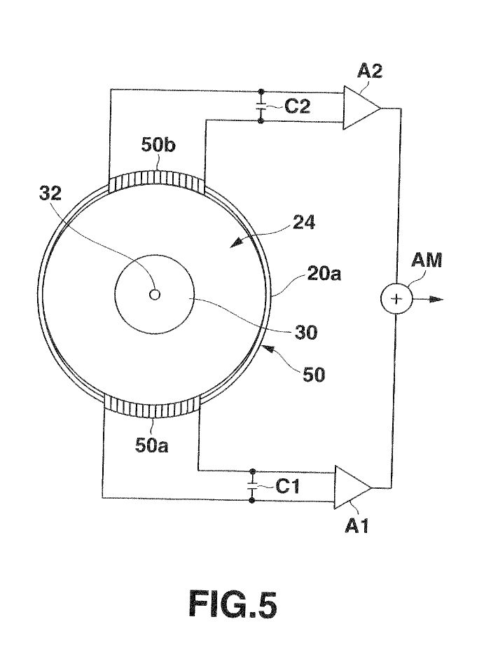

Next, a second modification of the antenna device 20 which is combined with the watch module 24 as the radio wave-using operation module block of FIG. 3A, will be described with reference to FIG. 5.

An antenna device 50 of the second modification is different from the antenna device 20 of the embodiment described above with reference to FIGS. 1 to 3B in that two antenna coils 50a, 50b are wound around two parts opposing to each other on the circular shaped antenna core member 20a. The diameter and the number of windings of one of the two antenna coils 50a, 50b are the same as those of the other. Both ends of the one antenna coil 50a are connected to an amplifier A1 through a condenser C1, and both ends of the other antenna coil 50b are connected to an amplifier A2 through a condenser C2. Two amplifiers A1 and A2 are connected to the above described well known time piece circuit in the watch module 24 through an adder AM, These condensers C1 and C2, amplifiers A1 and A2, and adder AM are included in the various received signal-using elements 22 of the watch module 24.

The radio wave receiving sensitivity of the antenna device 50 of the second modification configured as described above is about twice that of the antenna device 20 of the one embodiment which has only one antenna coil 20b as shown in FIGS. 3A and 3B.

In this modification, the two antenna coils 50a and 50b can be different from each other in the number of windings so that the antenna device 50 of the second modification can receive two radio waves which are different from each other in their frequencies corresponding to the number of windings of the two antenna coils 50a and 50b. In this case, when the cross sectional area of each of two positions between the two antenna coils 50a and 50b on the antenna coil member 20a is set to be smaller than the cross sectional area of each of the two parts of the antenna coil member 20a around which the two antenna coils 50a and 50b are wound, the radio wave receiving sensitivity of the antenna device 50 to the radio waves of the two frequencies which can be received by the antenna device 50 through the two antenna coils 50a and 50b can be improved.

[Third Modification of the Antenna Device 20]

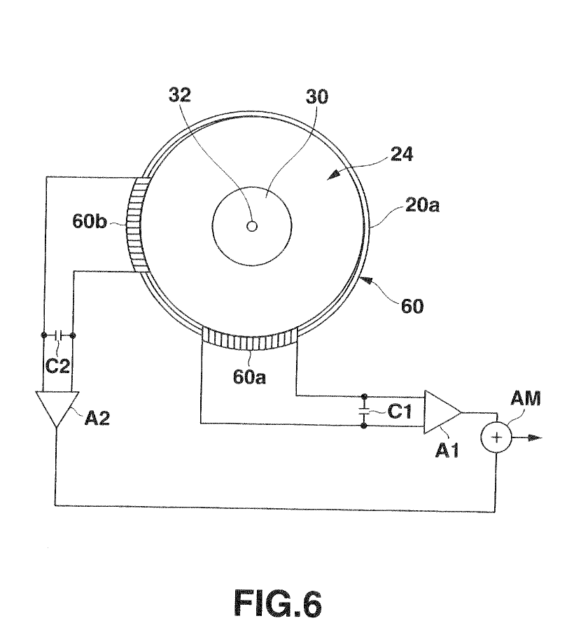

Next, a third modification of the antenna device 20 which is combined, with the watch module 24 as the radio wave-using operation module block of FIG, 3A, will be described with reference to FIG. 6.

An antenna device 60 of the third modification is different from the antenna device 20 of the embodiment, described above with reference to FIGS. 1 to 3B in that two antenna coils 60a, 60b are wound around two parts separated from each other on the circular shaped antenna core member 20a. in this modification, the two parts are two angular positions separated by 90 degrees from each other along the circular shaped antenna core member 20a in the longitudinal direction thereof. Further, the diameter and the number of windings of one of the two antenna coils 60a, 60b are the same as those of the other. But, the two antenna coils 60a, 60b are different from each other in their winding directions.

Both ends of the one antenna coil 60a are connected to an amplifier A1 through a condenser C1, and both ends of the other antenna coil 60b are connected to an amplifier A2 through a condenser C2. Two amplifiers A1 and A2 are connected to the above described well, known, time piece circuit, in the watch module 24 through an adder AM. These condensers C1 and C2, amplifiers A1 and A2, and adder AM are included in the various received signal-using elements 22 of the watch module 24.

The antenna device 60 of the third modification configured as described above has no directivity to the radio waves which can be received by the antenna device 60, in comparison with the antenna device 20 of the one embodiment which is shown in FIGS. 3A and 3B and which has only one antenna coil 20b.

[Fourth Modification of the Antenna Device 20]

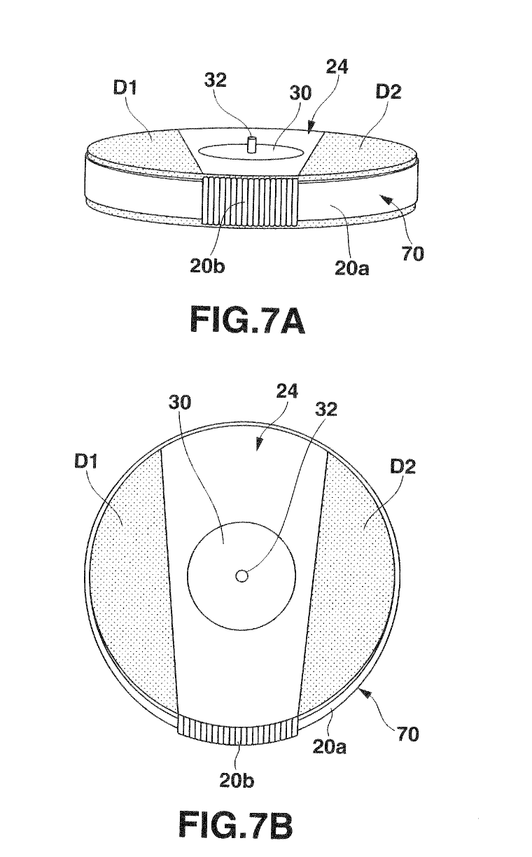

Next, a fourth modification of the antenna device 20 which is combined with the watch module 24 as the radio wave-using operation module block of FIG. 3A, will be described with reference to FIGS. 7A and 7B.

An antenna device 70 of the fourth modification is different from the antenna device 20 of the embodiment described above with reference to FIGS. 1 to 3B in that micro-magnetic materials each of which has for example the diameter of about 2 μm are mixed in two separated parts D1 and D2 of the resin on the outer surface region (including the two flat surfaces and the outer circumferential surface) of the watch module 24 adjoining the two parts of the circular shaped antenna core member 20a extending from the both side of the antenna coil 20b, and that the two magnetic material mixed parts D1 and D2 are magnetically connected to the two extending parts of the antenna core member 20a,

The two magnetic material mixed parts D1 and D2, together with the two extending parts of the antenna core member 20a, function to catch magnetic lines of radio waves. That is, the two magnetic material mixed parts D1 and D2 further improve the radio wave receiving sensitivity of the antenna device 70 of the fourth modification.

It is preferable that electrically conductive materials will not be arranged in the parts of the watch module 24 corresponding to the two magnetic material mixed parts D1 and D2.

The two magnetic material mixed parts D1 and D2 may be arranged only on the outer circumferential surface and one of the two flat surfaces of the watch module 24. In this case, the one flat surface preferably faces the watch glass 16 (see FIG. 2) covering the one opening 12d of the housing space 12a when the watch module 24 is housed in the housing space 12a of the watch case body 12. The reason for this arrangement is that radio waves can enter into the housing space 12a of the watch case body 12 through the one opening 12d most easily.

[Fifth Modification of the Antenna Device 20]

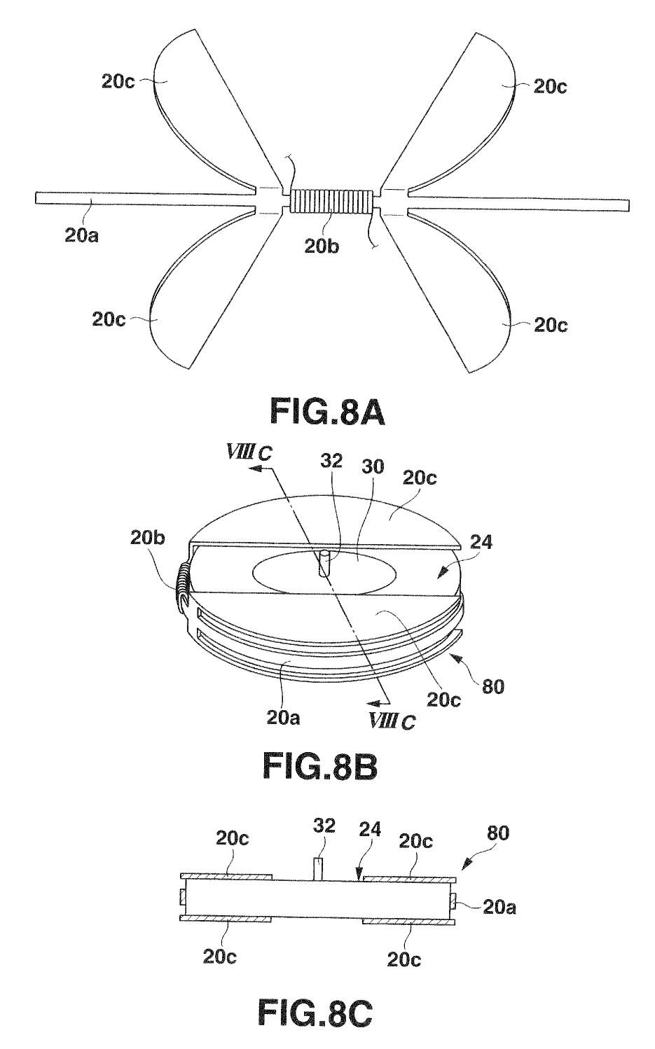

Next, a fifth modification of the antenna device 20 which is combined with the watch module 24 as the radio wave-using operation module block of FIG. 3A, will be described with reference to FIGS. 8A to 8C.

An antenna device 80 of the fifth modification is different from the antenna device 20 of the embodiment described above with reference to FIGS. 1 to 3B in that the antenna device 80 comprises at least one pair of, in this modification two pairs of, magnetic sheets 20c magnetically connected to the two extending parts of the antenna core member 20a. These magnetic sheets 20c are formed integrally with the antenna core member 20a by using the same material as that of the antenna core member 20a.

Specifically, each magnetic sheet 20c has a substantial crescent moon shape, and its one end is integrally connected to one side of each of the two parts of the antenna core member 20a adjoining the antenna core wound part thereof.

When the antenna core member 20a with the antenna coil 20b is arranged along the outer circumferential surface of the watch module 24, one paired magnetic sheets 20c are arranged at the two separated parts on one of the two flat surfaces of the watch module 24 to adjoin the outer circumferential surface thereof.

Alternatively, each of the two paired magnetic sheets 20c are arranged at the two separated parts on each of the two flat surfaces of the watch module 24 to adjoin the outer circumferential surface thereof.

In the case that one paired magnetic sheets 20c are arranged on one of two flat surfaces of the watch module 24, the one flat surface preferably faces the watch glass 16 (see FIG. 2) covering the one opening 12d of the housing space 12a when the watch module 24 is housed in the housing space 12a of the watch case body 12.

The function of the at least one pair, in this modification two pairs, of the magnetic sheets 20c combined with the antenna core member 20a, is the same as that of the two magnetic material mixed parts D1 and D2 of the antenna device 70 of the fourth modification shown in FIGS. 7A and 7B. Therefore, it is preferable that electrically conductive materials will not be arranged in the parts of the watch module 24 corresponding to the at least one pair, in this modification two pairs, of the magnetic sheets 20c.

[Sixth Modification of the Antenna Device 20]

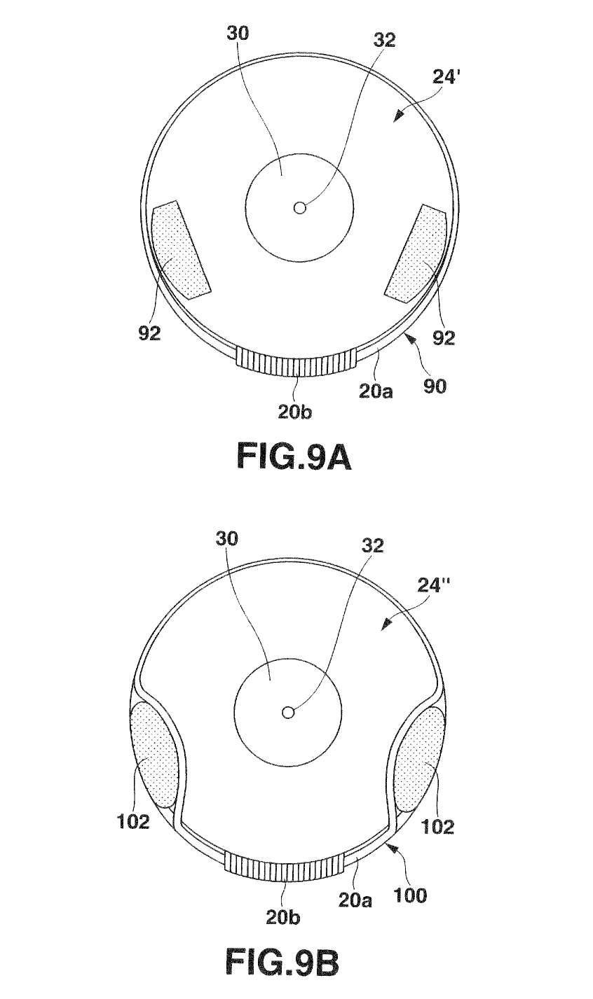

Next, a sixth modification of the antenna device 20 which is combined with a first modification of the watch module 24 as the radio wave-using operation module block of FIG. 3A, will be described with reference to FIG. 9A.

An antenna device 90 of the sixth modification is provided with the same combination as that of the antenna core member 20a and the antenna coil 20b in the antenna device 20 shown in FIGS. 3A and 3B.

The watch module 24′ of the first modification is different from the watch module 24 shown in FIGS. 3A and 3B in that two through holes are formed between the two flat surfaces of the watch module 24′ or two indents are formed only in one of the two flat surfaces of the watch module 24′ along two parts of the outer circumferential surface of the watch module 24′, on the two parts the two extending parts (both sides of the antenna coil wound part) of the antenna core member 20a being arranged.

Magnetic materials 92 are fitted in the two through holes formed between the two flat surfaces or in the two indents formed in the one of the two flat surfaces along two parts of the outer circumferential surface of the watch module 24′. The magnetic material 92 may be a gathering formed by solidifying a large number of micro magnetic materials each having a diameter of substantially 2 μm with such as resin.

The function of the two magnetic materials 92 is the same as that of the two magnetic material mixed parts D1 and D2 of the antenna device 70 of the fourth modification shown in FIGS. 1A and 7B, and the two magnetic materials 92, together with the antenna core member 20a with the antenna coil 20b, configure the antenna device 90 of the sixth modification.

The two magnetic materials 92 are magnetically connected to the two extending parts of the antenna core member 20a. Therefore, the two magnetic materials 92 may not be contacting directly to the two extending parts of the antenna core member 20a but be adjoining the two extending parts of the antenna core member 20a.

[Seventh Modification of the Antenna Device 20]

Next, a seventh modification of the antenna device 20 which is combined with a second modification of the watch module 24 as the radio wave-using operation module block of FIG. 3A, will be described with reference to FIG. 9B.

An antenna device 100 of the seventh modification is provided with the same combination as that of the antenna core member 20a and the antenna coil 20b in the antenna device 20 shown in FIGS. 3A and 3B.

The watch module 24″ of the second modification is different from the watch module 24 shown in FIGS. 3A and 3B in that two indents are formed only in one of the two flat surfaces of the watch module 24″ along two parts of the outer circumferential surface of the watch module 24″, on the two parts the two extending parts (both sides of the antenna coil wound part) of the antenna core member 20a being arranged.

A magnetic material 102 is fixed on the bottom surface of each of the two indents formed only in one of the two flat surfaces of the watch module 24″, to provide a predetermined gap between the inner surface of each indent and the outer circumferential surface of the magnetic material 102. And, two indent corresponding portions corresponding to the two indents formed in the outer circumferential surface of the watch module 24″, on the two extending parts of the antenna core member 20a are introduced along the inner circumferential surfaces of the two indents, and each indent corresponding portion is sandwiched between each magnetic material 102 in each indent and the inner circumferential surface of each indent.

The magnetic material 102 may be a gathering formed by solidifying a large number of micro magnetic materials each having a diameter of substantially 2 μm with such as resin.

The function of the two magnetic materials 102 is the same as that of the two magnetic material mixed parts D1 and D2 of the antenna device 70 of the fourth modification shown in FIGS. 7A and 7B, and the two magnetic, materials 102, together with the antenna core member 20a with the antenna coil 20b, configure the antenna device 100 of the seventh modification.

As shown in FIG. 9B, it is preferable that the two magnetic materials 102 in the two indents on the outer circumferential surface of the watch module 24″ of the second modification do not project outward from the two indents in the radial direction of the watch module 24″ beyond the extending lines of the outer circumferential surface in the two indents. Further, it is preferable that the two magnetic materials 102 do not project outward from the two indents in the direction along the center lone of the watch module 24″ beyond the one flat surface of the watch module 24″.

[Change in the Radio Wave Receiving Sensitivity of the Antenna Device Due to the Difference in the Length of the Antenna Core Member]

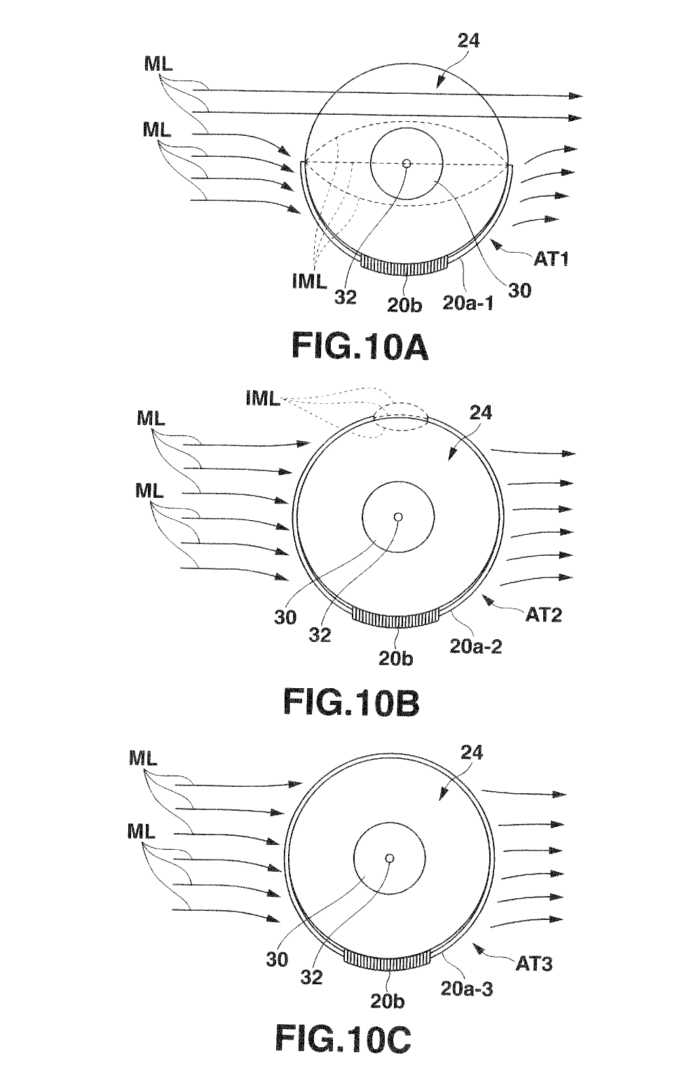

Next, change in the radio wave receiving sensitivity of the antenna device according to the present invention due to the difference in the length of the antenna core member will be described with reference to FIGS. 10A, 10B and 10C.

FIGS. 10A, 10B and 10C show three types of antenna devices AT1, AT2 and AT3, each of which is arranged on the outer circumferential surface of the watch module 24 shown in FIGS. 3A and 3B.

The antenna device AT1 shown in FIG. 10A comprises an antenna core member 20a-1 a length of which is a half of the length of the outer circumferential surface of the watch module 24, and an antenna coil 20b which is wound around the longitudinal center part of the antenna core member 20a-1. The both ends of the antenna coil 20b are connected to the well known time piece circuit configured by the various received signal-using elements 22 in the watch module 24.

The antenna device AT2 shown in FIG. 10B comprises an antenna core member 20a-2 a length of which is slightly shorter than the length of the outer circumferential surface of the watch module 24, and the antenna coil 20b which is wound around the longitudinal center part of the antenna core member 20a-2. The antenna core member 20a-2 of the antenna device AT2 and the antenna core member 20a-1 of the antenna device AT1 of FIG. 10A are different from each other only in their lengths. And, the antenna coil 20b of the antenna device AT2 is the same as the antenna coil 20b of the antenna device AT1 of FIG. 10A.

The antenna device AT3 shown in FIG. 10C comprises an antenna core member 20a-3 which extends over the whole outer circumferential surface of the watch module 24, and the antenna coil 20b which is wound around the longitudinal center part of the antenna core member 20a-3. The antenna core member 20a-3 of the antenna device AT3, the antenna core member 20a-1 of the antenna device AT1 of FIG. 10A and the antenna core member 20a-2 of the antenna device AT2 of FIG. 10B are different from each other only in their lengths. And, the antenna coil 20b of the antenna device AT3 is the same as each of the antenna coils 20b of the antenna devices AT1 and AT2 of FIGS. 10A and 10B.

When radio waves pass the watch module 24 with the antenna device AT1 as shown in FIG. 10A, magnetic lines ML which are away from the antenna core member 20a-1 only pass through the watch module 24. Magnetic lines ML which are near to the antenna core member 20a-1 or which cross the antenna core member 20a-1 are introduced into the antenna core member 20a-1 and generate electromotive force in the antenna coil 20b. The electromotive force generates induced magnetic lines which flow in the antenna core member 20a-1. Further, the induced magnetic lines IML flow between the extending ends of the two extending parts of the antenna core member 20a-1.

In the case that the length of the antenna core member 20a-1 is a half of the length of the outer circumferential surface of the watch module 24 as shown in FIG. 10A, the induced magnetic lines IML generated by the electromotive force pass through the watch module 24 between the extending ends of the two extending parts of the antenna core; member 20a-1. In this state, the induced magnetic lines IML generate eddy currents by metal parts in the watch module 24 so that loss in the electromotive force is produced. This makes the radio wave sensitivity of the antenna device AT1 shown in FIG. 10A being lowered.

When radio waves pass the watch module 24 with the antenna device AT2 as shown in FIG. 10B, all magnetic lines ML which cross the watch module 24 are introduced into the antenna core member 20a-2 and generate electromotive force in the antenna coil 20b. The electromotive force generated in the antenna device AT2 is far larger than that generated in the antenna device AT1. A large number of induced magnetic lines IML generated by the large electromotive force flow between the extending ends of the two extending parts of the antenna core member 20a-2.

As shown in FIG. 10B, the volume of a part of the watch module 24 positioned between the extending ends of the two extending parts of the antenna core member 20a-2 of the antenna device AT2 is very small. Therefore, the induced magnetic lines IML which flow in the part of the watch module 24 positioned between the extending ends of the two extending parts of the antenna core member 20a-2 do not generate eddy currents by the metal parts in the watch module 24. However, a part of the induced magnetic lines IML which flow between the extending ends of the two extending parts of the antenna core member 20a-2 in the outside of the watch module 24, flow in the not shown metal watch case which, houses the watch module 24 with the antenna device AT2 and generates eddy currents therein. Therefore, loss is slightly generated in the large electromotive force. This means that there is room for improving the sensitivity of the antenna device AT2 shown in FIG. 10B by the loss due to the eddy currents while the sensitivity of the antenna device AT2 is very larger than the sensitivity of the antenna device AT1 shown in FIG. 10A.

As shown in FIG. 10C, when radio waves pass through the watch module 24 with the antenna device AT3, almost all of the magnetic lines ML of the radio waves are introduced into the antenna core member 20a-3 and generate the large electromotive force by the antenna coil 20b, which is the same as that in the case shown in FIG. 10B but which is very larger than that in the case shown in FIG. 10A. Substantially all of the large number of induced magnetic forces IML generated by the large electromotive force, flow only in the circular antenna core member 20a-3.

The induced magnetic lines IML which flow only in the circular antenna core member 20a-3 of the antenna device AT3 will not substantially generate eddy currents by the metal parts in the watch module 24 and by the not shown metal watch case housing the watch module 24 with the antenna device AT3 shown in FIG. 10C. This means that the radio wave sensitivity Of the antenna device AT3 shown in FIG. 10C improves in comparison with the radio wave sensitivity of the antenna device AT2 shown in FIG. 10B.

The number of the induced magnetic lines IML generated in the antenna core member 20a-3 by the electromotive force generated by the magnetic lines ML of the radio waves is in proportion to the number of the magnetic lines ML of the radio waves which flow in the antenna coil wound part of the antenna core member 20a-3.

Therefore, in place of making the cross sectional area of the antenna core member 20a-3 being equal in the whole circular antenna core member 20a-3 as shown in FIG. 10C, it is preferable that the cross sectional area of the antenna core member 20a-3 is gradually increased from the part of the antenna core member 20a-3 located opposite to the antenna coil wound part thereof toward the antenna coil wound part thereof or that the magnetic resistance of the magnetic material forming the part of the antenna core member 20a-3 located opposite to the antenna coil wound part thereof is set be larger than that of the magnetic material forming the antenna coil wound part thereof.

With this configuration, the radio wave sensitivity of the antenna device AT3 shown in FIG. 10C can be improved without increasing the outer dimensions of the whole combination in which the antenna device AT3 is combined with the outer circumferential surface of the watch module 24.

[Manufacturing Process for the Circular Antenna Core Member]

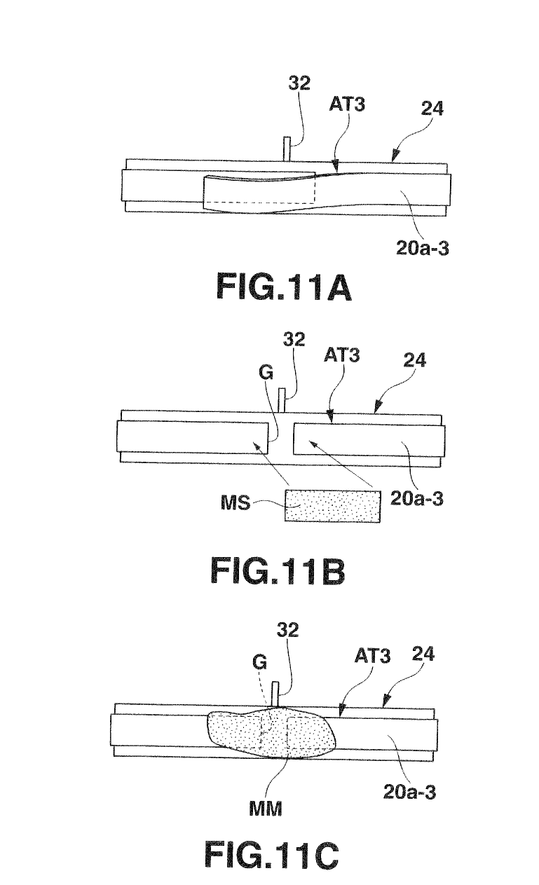

Next, three kinds of manufacturing processes for the circular antenna core member 20a-3 shown in FIG. 10C will be described with reference to FIGS. 11A, 11B and 11C.

In the process shown in FIG. 11A, the length of the antenna core member 20a-3 is set to be longer than that of the outer circumferential surface of the watch module 24 on which the antenna core member 20a-3 is arranged. Then, when the antenna core member 20a-3 is arranged at the predetermined position on the outer circumferential surface of the watch module 24, the extending ends of the two extending parts of the antenna core member 20a-3 are overlapped with each other as shown in FIG. 11A. If necessary, the overlapped extending ends of the two extending parts of the antenna core member 20a-3 are fixed with each other or to the outer circumferential surface by well known fixing means including an adhesive agent, an adhesive tape, and the like.

In the process shown in FIG. 11B, the length of the antenna core member 20a-3 is set to be slightly shorter than that of the outer circumferential surface of the watch module 24 on which the antenna core member 20a-3 is arranged. Then, when the antenna core member 20a-3 is arranged at the predetermined position on the outer circumferential surface of the watch module 24, a magnetic sheet MS is applied to the gap G produced between the extending ends of the two extending parts of the antenna core member 20a-3 to bridge the extending ends, and the magnetic sheet MS is fixed to the extending ends or the outer circumferential surface by well known fixing means including an adhesive agent. an adhesive tape, and the like.

In the process shown in FIG. 11C, the length of the antenna core member 20a-3 is set to be slightly shorter than that of the outer circumferential surface of the watch module 24 on which the antenna core member 20a-3 is arranged. Then, when the antenna core member 20a-3 is arranged at the predetermined position on the outer circumferential surface of the watch module 24, additional material MM which includes micro-magnetic materials and which is for example an adhesive agent is applied to the gap G produced between the extending ends of the two extending parts of the antenna core member 20a-3 to bridge the extending ends.

[Manufacturing Process of the Elongate Antenna Core Member]

The elongate antenna core member used in the antenna device according to the present invention is manufactured by stacking a plurality of elongate sheet shaped magnetic materials with each other or by integrally forming with the magnetic material in the above described embodiment and in the above described various modifications. However, the final elongate antenna core member can be formed by folding a sheet of magnetic material which has the same length and a wider width as those of the final elongate antenna core member to have the same width as that of the final elongate antenna core member. Alternatively, the final circular elongate antenna core member can be formed by coiling one line member of magnetic material many times. Further, the final elongate antenna core member can be formed by bundling many line members of magnetic material each having the predetermined length to have the predetermined width as a whole.

[Modifications of the Radio Wave-Using Apparatus]

In the above described embodiment and various modifications, the radio wave-using apparatus using the antenna device according to this invention is the wrist watch type radio wave controlled time piece. However, according to an aspect of the present invention, the radio wave-using apparatus may be a desk-top type, a wall-hanging type or a floor-standing type radio wave controlled clock, a portable radio or a portable terminal, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna device, which receives radio waves, which excites received signals corresponding to the received radio waves, and which transmits the received signals to a radio wave-using operation module block including received signal using elements, the radio wave-using operation module block including a pair of flat surfaces facing in opposite directions and an outer circumferential surface connecting the peripheral edges of the flat surfaces to each other, the antenna device comprising:
an elongate antenna core member which extends along the outer circumferential surface of the radio wave-using operation module block; and
an antenna coil which is wound around at least a part of the antenna core member in the longitudinal direction thereof and which is connected to the received signal using elements of the radio wave-using operation, module block.

2. The antenna device according to claim 1, wherein the antenna core member extends circularly along the whole circumferential surface of the radio wave-using operation module block.

3. The antenna device according to claim 2, wherein the antenna coil is wound around a part of the antenna core member in the longitudinal direction thereof, and
the cross-sectional area of the part of the antenna core member where the antenna coil is wound is larger than the cross-sectional area of a part of the antenna core member located to oppose to the antenna coil wounded part.

4. The antenna device according to claim 1, wherein the antenna core member includes a plurality of laminated elongate sheet-like magnetic materials.

5. The antenna device according to claim 1, further comprising at least a pair of magnetic sheets which are placed at separated two positions along at least one of the paired flat surfaces of the radio wave-using operation block, and which are magnetically connected to two parts located on both sides of the antenna coil wound part in the antenna core member.

6. The antenna device according to claim 1, further comprising a pair of magnetic sheets which are placed at separated two positions along each of the paired flat surfaces of the radio wave-using operation block, and which are magnetically connected to two parts located on both sides of the antenna coil, wound part in the antenna core member.

7. The antenna device according to claim 1, wherein at least one of the paired flat surfaces of the radio wave-using operation module block is covered with resin, and
magnetic material is mixed in two separated parts of the resin, and the two magnetic material mixed parts are magnetically connected to two parts located on both sides of the antenna coil wound part in the antenna coil member.

8. The antenna device according to claim 1, wherein both of the paired flat surfaces of the radio wave-using operation module block are covered with resin, and
magnetic material is mixed in two separated parts of resin on each of the paired flat surfaces, and the two magnetic material mixed parts of resin on each of the paired, flat surfaces are magnetically connected to two parts located on both sides of the antenna coil wound part in the antenna coil member.

9. The antenna device according to claim 1, wherein a plurality of antenna coils are wound around a plurality of parts of the antenna core member separated in the longitudinal direction thereof, each antenna coil connected to the received signal using elements of the radio wave-using operation module block.

10. The antenna device according to claim 9, wherein the plurality of antenna coils are different from each other in the numbers of windings.

11. A radio wave-using apparatus comprising:
an antenna device which receives radio waves and which excites received signals corresponding to the received radio waves;
a radio wave-using operation module block which includes received signal using elements using the received signal excited by the antenna device; and
a case which has a housing space housing the antenna device and the radio wave-using operation block,
the radio wave-using operation module block including a pair of flat surfaces which face in opposite directions, and an outer circumferential surface which connects the peripheral edges of the flat surfaces, and
the antenna device including an elongate antenna core member which extends along the outer circumferential surface of the radio wave-using operation module block, and an antenna coil which is wound around at least a part of the antenna core member located in the longitudinal direction thereof, and which is connected to the received signal using elements of the radiowave-using operation module block.

12. The radio wave-using apparatus according to claim 11, wherein the case includes at least one opening on its surface to connect the housing space to an outside space, and a light transmittable material covering the opening,
the radio wave includes time data,
the radio wave-using operation block module includes a time display unit which is visible from the outside space through the light transmittable material of the at least one opening of the case, and
the received signal using elements of the radio wave-using operation module block updates the current time displayed on the time display unit in accordance with the time data included in the received radio wave.

13. The radio wave-using apparatus according to claim 11, wherein the case includes an inner circumferential surface which is adjacent and opposite to the elongate antenna core member of the antenna device extending along the outer circumferential surface of the radio wave-using operation module; block, in the housing space.

14. The radio wave-using apparatus according to claim 11, wherein the antenna core member extends circularly along the whole circumferential surface of the radio wave-using operation module block.

15. The radio wave-using apparatus according to claim 14, wherein
the antenna coil is wound around a part of the antenna core member in the longitudinal direction thereof, and
the cross-sectional area of the part of the antenna core member where the antenna coil is wound is larger than the cross-sectional area of a part of the antenna core member located to oppose to the antenna coil wounded part.

16. The radio wave-using apparatus according to claim 11, wherein the antenna core member includes laminated elongate sheet-like magnetic materials.

17. The radio wave-using apparatus according to claim 11, further comprising at least a pair of magnetic sheets which are placed at separated two positions along at least one of the paired flat surfaces of the radio wave-using operation block, and which are magnetically connected to two parts located on both sides of the antenna coil wound part in the antenna core member.

18. The radio wave-using apparatus according to claim 11, wherein at least one of the paired flat surfaces of the radio wave-using operation module block is covered with resin, and
magnetic material is mixed in two separated parts of the resin, and the two magnetic material mixed parts are magnetically connected to two parts located on both sides of the antenna coil wound part in the antenna coil member.

19. The radio wave-using apparatus according to claim 11, a plurality of antenna coils are wound around a plurality of parts of the antenna core member separated in the longitudinal direction thereof, each antenna coil connected to the received signal using elements of the radio wave-using operation module block.

20. The radio wave-using apparatus according to claim 19, wherein the plurality of antenna coils are different from each other in the numbers of windings.
